(19) United States
(12) Patent Application Publication
(10) Pub. No.: US 2014/0201667 A1
(43) Pub. Date: Jul. 17, 2014

(54) System and Method for Generating and Displaying Climate System Models

(71) Applicant: Barbara Schoeberl, Silver Spring, MD (US)

(72) Inventor: Barbara Schoeberl, Silver Spring, MD (US)

(21) Appl. No.: 14/216,119

(22) Filed: Mar. 17, 2014

Related U.S. Application Data
(63) Continuation-in-part of application No. 13/410,603, filed on Mar. 2, 2012.
(60) Provisional application No. 61/448,498, filed on Mar. 2, 2011.
(60) Provisional application No. 61/793,746, filed on Mar. 15, 2013.

(51) Int. Cl. G06F 3/0484

(52) U.S. Cl. CPC G06F 3/04842
USPC 715/771

(57) ABSTRACT

An embodiment of the invention provides a method for generating and displaying earth science system models where global earth data is collected, the global earth data including image data and text data, the global earth data further including atmospheric data, hydrospheric data, lithospheric data, cryospheric data, biospheric data, and/or anthrospheric data. Still graphical reference images may also be available as overlays. The collected global data is processed into images and common format data products. There are two types of images, a base layer, which included the data over a map of the earth and the overlay, which has just the data and no earth image. The second global image (transparency layer) can be superimposed over the first global image (base layer). The following can be selected by the end user, the base layer data, the adjustable transparency layer data, the time range, the global orientation and speed, the rate of data advancement, and a zoom function. Animation sequences can be generated by the end-user for any of the above selections.

### CROSS-REFERENCE TO RELATED APPLICATIONS

This application is a continuation-in-part application of U.S. patent application Ser. No. 13/410,603, filed Mar. 2, 2012, which claims priority from U.S. provisional Application Ser. 61/448,498 filed Mar. 2, 2011.

This application also claims priority from U.S. Provisional Application Ser. No. 61/793,746 filed Mar. 15, 2013. Each of the above mentioned patent applications are hereby incorporated by reference.

### BACKGROUND

The present invention is in the field of systems, methods, and computer program products for generating and displaying satellite and ground observed earth observations.

Much can be learned about the health of the earth by studying the dynamic interdependent relationships between the atmosphere (air), hydrosphere (water), lithosphere (land), cryosphere (ice), and biosphere (life), collectively referred to as the five elemental spheres. Comparing and contrasting earth-observing satellite data from different sources deepens researchers' understanding of earth systems and the interdependency between different natural forces.

Until recently, the components comprising the five elemental spheres have been studied independently as their own respective disciplines. The importance of studying earth as a whole is now recognized in order to understand the complex interrelationships and interdependencies of the different natural and anthropogenic forces. However, until this invention, tools for studying earth observations across different disciplines were sparse to non-existent. Where they existed at all, the products were not comprehensive or easy to use. Earth Today, in addition to combining products from different fields of earth science research has added a sixth element, human influence is also being studied, called the anthrosphere.

History of data availability. In the 1980-90's global observational satellite data sets managed by researchers were so large (relative to the existing processing/storage power) that only government centers and a few universities could store or access the data.

In the 2000's NASA EOS made data products publicly available. However, data sets were still extremely large and multiple data products, sometimes hundreds of data products, were bundled together with little or no documentation about the data products. It was nearly impossible to determine how to identify and process the desired products contained within the bundle. As a consequence, only those who regularly worked with the data could effectively use or process these data. NASA, NOAA and European data centers struggled to provide effective data ordering and delivery systems and reprocess data sets in a timely way.

By the 2010's, each scientific discipline had already independently developed their own unique software and process for their data. The variety of data formats and different mapping systems employed by different satellites and sensors is bewildering. Data set documentation ranges from usable, to confusing to non-existent. Until this invention, there was no practical way to compare archived or near-real-time data from different sources.

Earth Today makes accessible a wide range of data sets spanning many earth science disciplines to be observed and compared as images or time sequences from the most recent observations to as far back as each data set has been available. This data is available as image sequences and as data products that have been reformatted in consistent, easy-to-use common data formats (NetCDF and idl .sav). The images are accessible through an easy to use graphical user interface (GUI) interface.

### SUMMARY OF THE INVENTION

An embodiment of the invention provides a system and method for generating and displaying earth observing satellite observations. More specifically, a proprietary data ingest program automatically ingests global data products and extracts the desired global earth data set from the larger collection. Earth Today repeats this ingest function from multiple data sources, wherein the global earth generates data products in at least five different formats (images, overlay transparent images, Keyhole Markup Language (KML), NetCDF files and idl .sav. files. The range of global earth data provided includes atmospheric, hydrospheric, lithospheric, cryospheric, biospheric, and anthrospheric.

A processor connected to the data collector reprocesses the global earth data into a first format (base layer) or a second format (overlay with transparency). The processor generates global images based on the extracted global earth data, wherein the global images display the global earth data into a cylindrical map projection which can be displayed on a spherical projection. A display device such as a computer+monitor or other display device that receives the final imagery from the processor displays the processed global data sets. There are two types of images; a base layer, which included the data over a map of the earth and the overlay, which has just the data and no earth image. The second global image (transparency layer) can be superimposed over the first global image (base layer). The first global image, herein referred to as “the base layer”, includes the data displayed plus an underlying earth image for geographical reference. The second global image, herein referred to as “the overlay layer”, contains only the satellite observations and does not include an earth image. The overlay layer has an adjustable transparency capability allowing a dynamic comparison between the base layer and the overlay. The overlay layer has a transparency feature allowing the user to adjust the transparency to better compare the two layers. Overlaying a second data set is optional if the viewer desires to only observe the base layer. Both layers contain the same range of data sets.

It is an object of the invention to provide a system and method that automatically extracts near-real-time global earth data from multiple independent data sources at predetermined time intervals without human interaction.

It is another object of the invention to provide a system and method that generates a series of images from the extracted global earth data, wherein the global earth images can be displayed digitally either as a flat earth image or on a spherical earth projection. It is still another object of the invention to provide a system and method that can superimpose two or more user-selected types of global earth data (e.g., rainfall and cloud cover) from near-real time as well as archival images.

It is yet another object of the invention to deepen understanding of earth systems and the interdependency between different natural forces by providing a system and method that compares and contrasts global data representing all five elemental sources plus sociological data sets which address human activities. The five elemental spheres are atmospheric, hydrospheric, lithospheric, cryospheric, biospheric plus anthrospheric, or human activity.

It is still yet another object of the invention to provide a system and method that facilitates observation of relationships between divergent sets of earth-observing data from the five elemental spheres by collecting daily near-real time data that is added to a growing data base that extends from the present day to as far back as each data product is first available. The data-derived images can then be displayed digitally as a flat earth image or as a spherical earth projection. The selection data to be displayed and several variables about the display can be controlled by the end-user through a GUI interface.

It is another object of the invention to use this invention as a tool that can improve the study of earth science and can be used in a wide variety of applications, including formal and informal education (K-12, college, and graduate programs), by scientists, weather stations, and the curious general public.

It is another object of the invention to provide an intuitive GUI interface to facilitate the user interaction and ability to quickly and easily access the earth images.

### BRIEF DESCRIPTION OF THE SEVERAL VIEWS OF THE DRAWINGS

The present invention is described with reference to the accompanying drawings. In the drawings, like reference numbers indicate identical or functionally similar elements.

FIG. 1 illustrating a system according to an embodiment of the invention.

FIG. 2 is a table illustrating global earth-observing data sets from five elemental spheres and the anthrosphere according to an embodiment of the invention.

FIG. 3 illustrating a system according to another embodiment of the invention.

FIG. 4 illustrates a system generating and displaying climate system models according to an embodiment of the invention.

FIG. 5 is a flow diagram illustrating a method for generating and displaying climate system models according to an embodiment of the invention.

FIGS. 6A, 6B and 6C illustrate an interface according to an embodiment of the invention.

FIG. 7 is a flow diagram illustrating a method for generating and displaying climate system models according to an embodiment of the invention.

### DETAILED DESCRIPTION

Exemplary, non-limiting, embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

An embodiment of the invention provides a system (also referred to herein as the “Earth Today system”) that displays near-real-time images (e.g., within 24 hours of measurement) of global earth observing data sets from five elemental spheres, namely, the atmosphere, hydrosphere, geosphere or lithosphere, cryosphere, and biosphere. When visually compared, an end-user can identify relationships between such data sets. End-users can also compare current data sets with historical data. Additionally, sociological data sets can be added which represent the anthrosphere, or structures and systems constructed or modified through human activity.

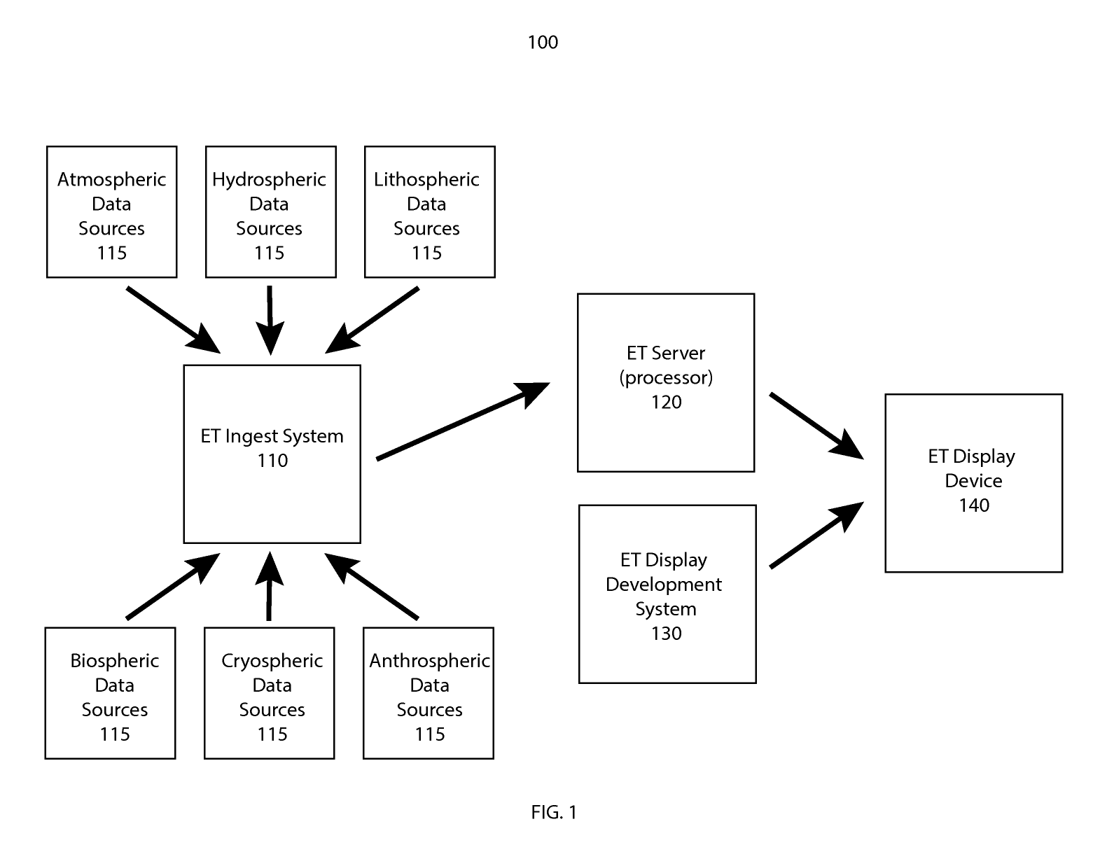

FIG. 1 illustrates a system 100 according to an embodiment of the invention. The system 100 includes an ingest system 110, an Earth Today server 120, and a display system 130. The ingest system 110 automatically ingests/retrieves data from various sources and unpacks the data from its native format. The second part, the Earth Today server 120, processes the ingested and unpacked data into image files, reprocesses the data files into common easy to use formats, archives the images and data, and prepares the images and data for distribution to end-users. A third part is the development system 130 in which the graphical user interface (GUI) and system program are developed, updated and maintained. The fourth part, the display system 140, is an update and display software package that resides on an end-user's computer. The display system 140 allows the end-user to receive the most recent updates from the server, and provides an intuitive graphical user interface (GUI) that allows the end-user to view and manipulate the data sets, which reside on the end-user's computer.

The ingest system 110 can acquire global earth-observing satellite data sets from public archives where scientific data is posted at least once daily—some data are posted multiple times per day. Exemplary data sets representing the five elemental spheres include, but are not limited to, atmospheric data (air—meteorological, trace gas, aerosol, etc.), biospheric data (life—vegetation on land and chlorophyll in the sea), hydrospheric data (water—ocean temperatures, rainfall, lighting), lithospheric data (land—earthquakes and volcanoes, soil moisture), cryospheric data (ice—snow and ice covering both land and sea), and anthrosphere (human—lights at night, population, energy use, fires, birth/death rates). Much of the data is publicly available and may be acquired from government sources such as, for example, National Aeronautics and Space Administration (NASA) and National Oceanic and Atmospheric Administration (NOAA) satellites and ground-based observations by United States Geological Survey (USGS) observatories. Sociopolitical, (anthrospheric) data can be acquired from the Center for International Earth Science Information Network (CIESIN). Data sets from international sources may be included.

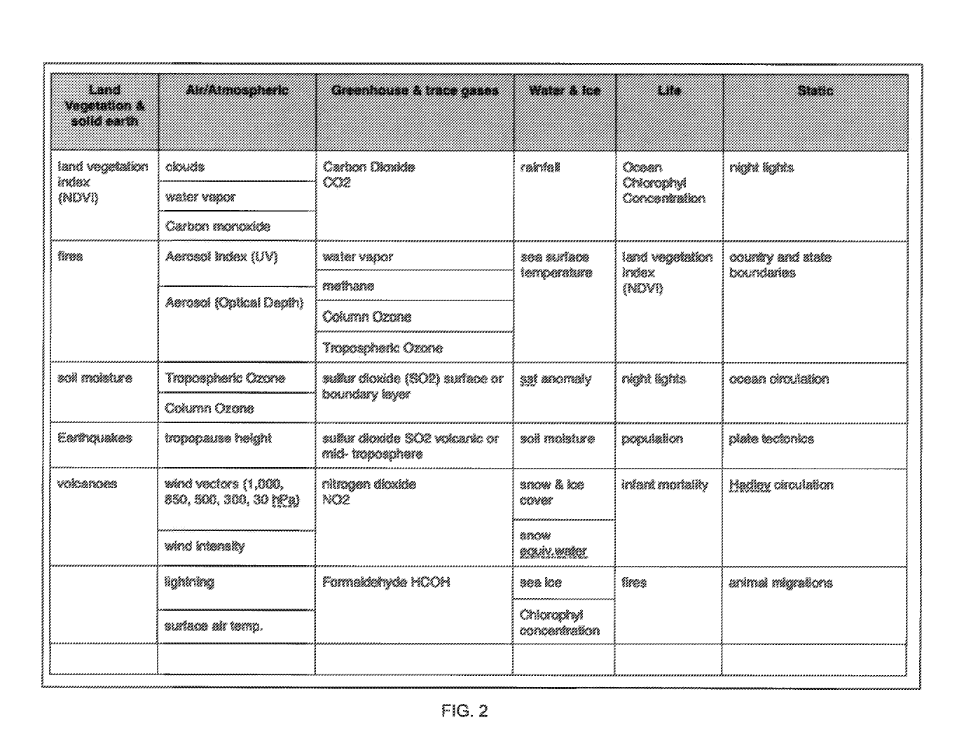

FIG. 2 is a table illustrating exemplary global earth observing data sets from the five elemental spheres and the anthrosphere.

In at least one embodiment of the invention, the ingest system 110 logs onto a series of File Transfer Protocol (FTP) or Hypertext Transfer Protocol (HTTP) sites and checks if new data has been posted. If there is new data, the data is transferred to the proprietary data ingest programs. Specifically, the ingest system 110 can include software having a series of stand-alone routines for each data product, wherein each code has the following generic structure: using system date-time identifiers, we form the access file name and use Wget to access remote servers and locate the most updated file. This file is transferred to the local computer (e.g., via FTP). Files of interest are originally imbedded in several different format files that are natively incompatible with one another and are often difficult to access and interpret. Earth Today approaches each individual data set differently based on the native data format and processes governing the data. The system also includes special codes to reprocess data or extend the data range. These formats include, but are not limited to, Hierarchal Data Format 5 (HDF5), Hierarchal Data Format-Earth Observing System (HDF-EOS), Network Common Data Form (NetCDF), or Gridded Binary or General Regularly-distributed information in Binary Form (GRIB). The codes extract the data from these files. For example, Google Earth files (in Keyhole Markup Language (KML)) are downloaded where data is extracted from these files.

Once the data of interest is extracted and unpacked, it is processed through a program to prepare imagery generated for each data set to be compatible in size, shape, and time sequencing so it can be compared with every other data set in the Earth Today system. The data fields may be further processed to create more usable data. For example, very high resolution data may be re-gridded to lower resolution by averaging data within larger grid boxes. Data flags and data statistics can be used to reject bad data. If there is missing data due to incomplete coverage, data from the previous day may be used to fill in gaps as appropriate. Fourier filters and box car smoothing algorithms may be applied to noisy data to reduce noise.

Once the data processing is complete, an image generation module (also referred to herein as the “processor”) generates an image of the data. The image generation module automatically creates an image for the display system 140 (e.g., 512×1024 or a higher resolution 1024×2048 .png image file) and/or a Google earth's Keyhole Markup Language (KML) file, which includes a color bar and legend. In at least one embodiment, the image of the data is produced on a cylindrical map projection for creating a global map. The image generation module archives the data, image, and/or KML file, for example, as NetCDF or interface description language (IDL .sav) files.

In at least one embodiment of the invention, each data set that is processed by the ingest system 110 has a unique data generation program (UDGP). That is, there is a separate and unique code for processing each data set. For instance, lightning data has its own separate code; chlorophyll has its own separate code, etc. Underlying these separate codes is the image generating software, date/time management software, etc. Some UDGP's produce multiple useful data sets. For example the sea surface temperature (SST) software produces SST's, SST anomalies, and coral reef stress. The ingest system 110 is configured so that it can run each UDGP at a different time of the day (e.g., using CRON jobs) to provide minimum stress on network bandwidth and processing resources. Some UDGP's can run multiple times a day to provide more frequent updates. One embodiment of the invention includes over 30 UDGP's written in IDL with over 50 specialized supporting routines.

In at least one embodiment, the server 120 manages the automatic logins and contains the archive folders for the data and images. The server 120 can bring updated images over from the ingest system 110 and from other sources as appropriate, and can provide the images to the display system 130. In one embodiment, the server 120 software is UNIX-based C++ custom coded script. The server 120 can perform updates several times a day and can move images that it ingests into product-specific files or “folders”. When updating the display system from the archive, the display system 140 can log onto the server 120 and bring over the most recent data and missing data from the archive.

The display system 140 runs on a client computing device such as an appropriately configured laptop or desktop computer, a kiosk, or a computer cloud-based system, a spherical projection or other digital devices. In at least one embodiment, the display system 140 includes update software, which, when it is run, logs onto the server 120, compares the archive on the end-user's computer with the server 120 archive, and brings the end-user's archive up to date.

At least one embodiment of the invention uses touch screen GUI interface controls, where the end-user selects the data sets of interest and the date ranges for those data sets. The appropriate images have been transferred to and are located within the archive on the end-user's ET Display device. The end user is able to generate and instantly view a data animation by rapidly displaying the images in a sequence. The resulting animation is shown on the screen image of a rotating earth globe. The touch screen GUI controls allow the end-user to select the data displayed and control several parameters including rotating the globe, controlling the speed of the globe's rotation, and/or the data advancement as well as zoom in or out of the global image. The system can display one data set and can also overlay a second transparent layer data set over the first. The degree of transparency of the overlay can be adjusted by the end user through the GUI interface. This enables the end-user to distinguish the two data sets (base layer plus transparency overlay)—for example, clouds and precipitation or ozone and the jet stream.

The system is an effective tool in both formal and informal educational settings. It can be used by academic and research scientists in the course of their work to discuss science with their peers and investigate inter-relationships between data. Moreover, the system can be used as a browse tool to quickly scan through massive amounts of data, and to explain science to students and as well as to the general public.

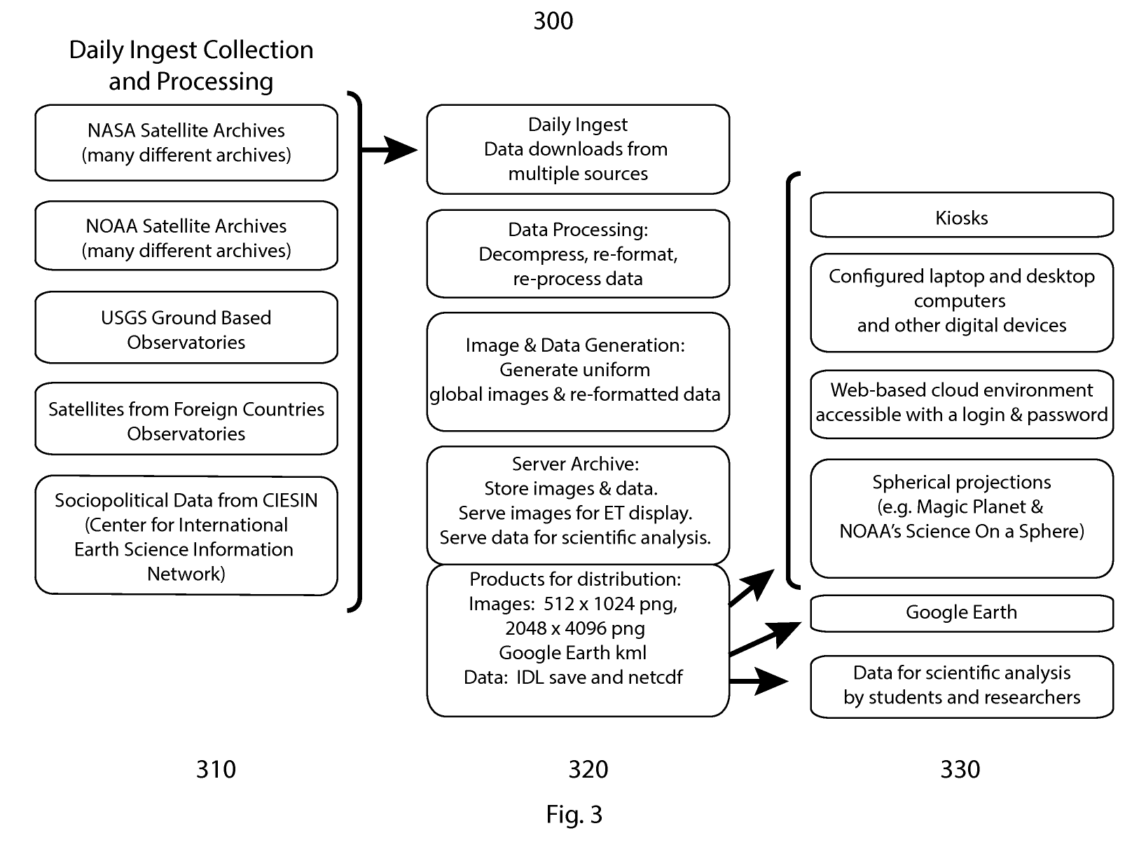

FIG. 3 illustrates a system 300 according to another embodiment of the invention, wherein the system 300 includes data archive sources 310, an ingest and processing module 320, and displays 330. The data archive sources 310 include data from NASA satellite archives, NOAA satellite archives, USGS ground based observatories, and sociopolitical data from the Center for International Earth Science Information Network. The ingest and processing module 320 is connected to data archive sources 310, and includes a daily ingest module, a data processing module, an image and data generation module, and a server archive module. As used herein, the term “connected” includes operationally connected, logically connected, in communication with, physically connected, engaged, coupled, contacts, linked, affixed, and attached. In at least one embodiment, each of the modules in the ingest and processing module 320 are on the same computer. The displays 330 include kiosks, laptop and desktop computers, a web-based cloud environment, spherical projections, Google™ Earth, hand-held devices, and displays for researchers and students.

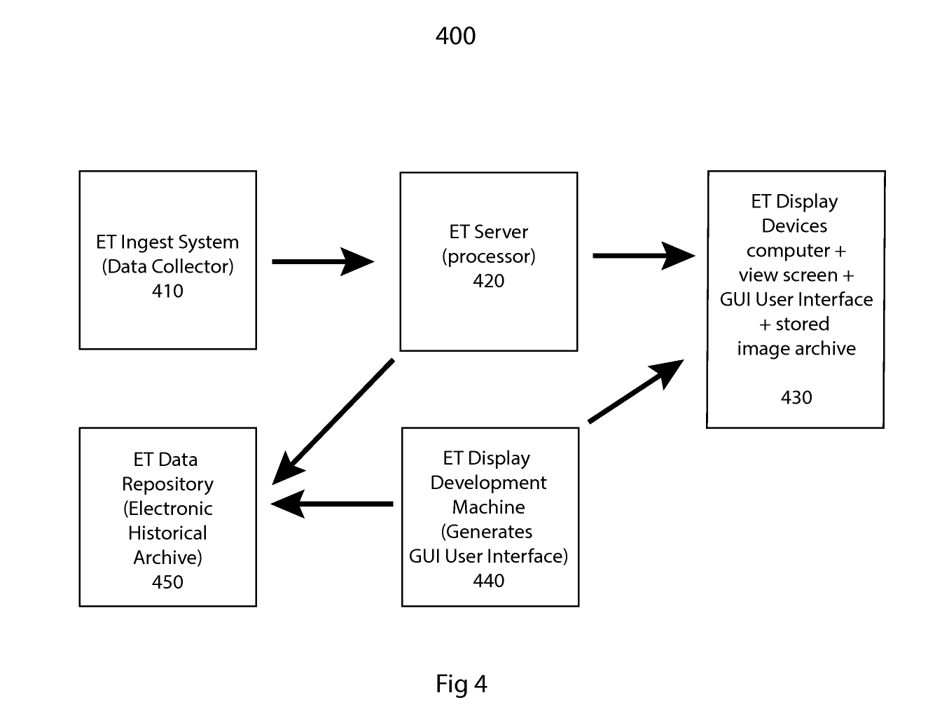

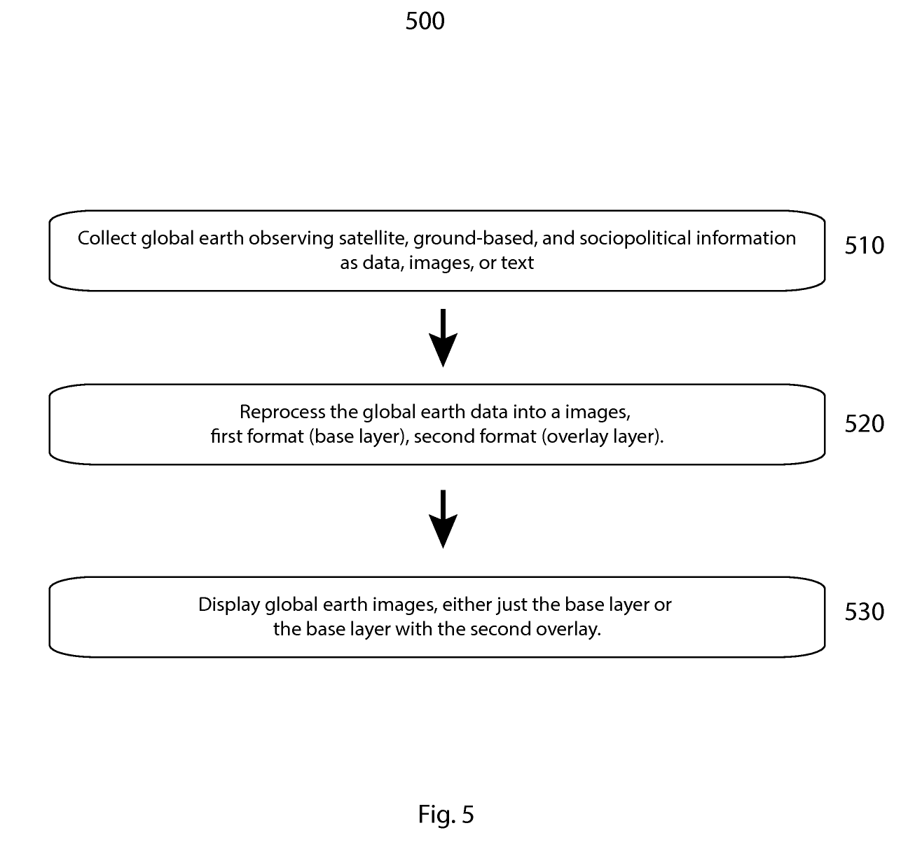

FIG. 4 illustrates a system 400 for generating and displaying climate system models according to an embodiment of the invention. The system includes a data collector 410, processor 420, display device (including computer, view screen, GUI interface, archived images) 430, ET Display Development Machine which designs, generates, updates the GUI user interface 440, data repository 450. In at least one embodiment, the data collector 410, processor 420, display 430, display development 440, the data repository 450, and/or the display development machine may reside on the same computer. FIG. 5 is a flow diagram illustrating a method for generating and displaying earth science observations according to an embodiment of the invention, for example, using the system 400.

The data collector 410 (also referred to herein as the “ingest system”) collects global earth data in image and/or text format 510. In at least one embodiment, the global earth data includes both image data and text data. The global earth data includes atmospheric data (e.g., meteorological data, trace gas data, and aerosol data), hydrospheric data (e.g., sea surface temperature data, sea surface temperature anomaly data, rainfall, lighting strikes), lithospheric data (e.g., seismic data, volcano data, soil moisture data), cryospheric data (e.g., snow data and ice data), biospheric data (e.g., land vegetation and ocean chlorophyll), and/or anthrospheric data (e.g., lights at night, human population data, energy use data, fire data, birth & death data). A series of still graphical reference images will include but not be limited to the following; plate boundaries with differentiated earthquake faults, geographical boundaries, coral reef locations, a graphic model of wind current patterns, etc.

In at least one embodiment of the invention, the data collector 410 automatically extracts global earth data from multiple data sources at predefined time intervals. For example, the data collector 410 can be programmed to extract global earth data from NOAA's website every 60 minutes. In another example, the data collector 410 is programmed to extract global earth data from NASA's website every Monday morning at 7:00 AM). Once the data collector 410 is programmed, it can automatically extract global earth data without human interaction.

As described above, the ingest system extracts data whose native formats vary between the separate and independent sources/archives. The data is unpacked and processed (i.e., cleaned up, decompressed, and reformatted into common easy to use formats). The data collector 410 is connected to the ET processor.

420 (also referred to herein as the “Earth Today server”). In at least one embodiment of the invention, some data collection functions 410 may reside on the Earth Today Server 420. In at least one embodiment, the global earth data includes data in at least three different formats, wherein the processor 420 reprocesses (i.e., converts) the global earth data into a first format, base layer, or a second format, overlay layer 520. As described above, the ingest system extracts data stored in a variety of formats from separate and independent sources/archives. The data is unpacked and processed (i.e., cleaned up, decompressed, and reformatted into common easy-to-use image and data formats).

The Earth Today Server 420 generates global images derived from the collected global earth data 520, wherein the cylindrical global images are projected onto a spherical map of the earth. Specific areas can be enlarged through a zoom function in the GUI interface.

The Earth Today Server (processor) 420 is connected to the Earth Today display 430, wherein the display 430 can superimpose a second global image over the first global image 530. More specifically, the first global image, the base layer, includes first global earth data (e.g., wind speeds) plus an underlying earth image for geographical reference and an optionally selected second global image (e.g., clouds). The second global image can be superimposed over the first global image, wherein the transparency of the second global image can be adjusted via the user interface 440. In at least one embodiment of the invention, where a time sequence has been selected, the image of one or possibly two images can be animated, showing a time-sequence of the one data set or the interaction of two data sets over the time period selected. For example, the viewer may see rainfall (precipitation) superimposed over clouds and animated a selected time period of the two layers together, depicting the intensity and location of the rain within the clouds. The global earth data and/or global images are stored in the data repository 450 (also referred to herein as the “electronic historical archive”). In at least one embodiment, the global images displayed are retrieved from the data repository 450.

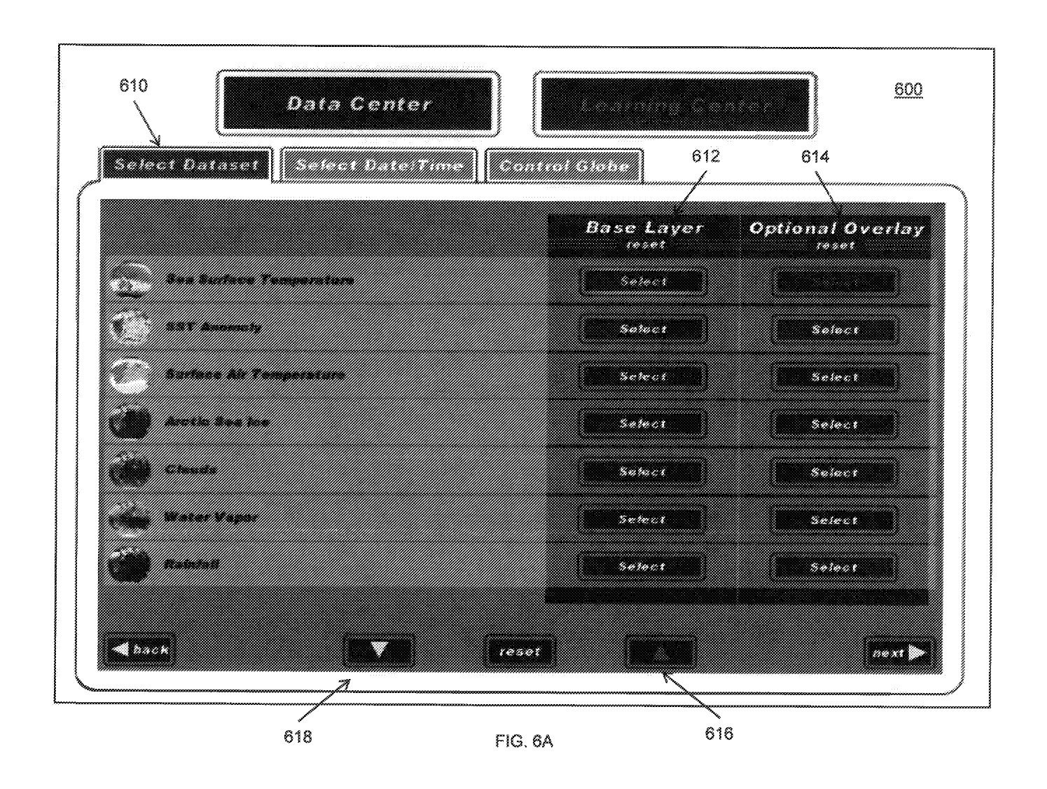

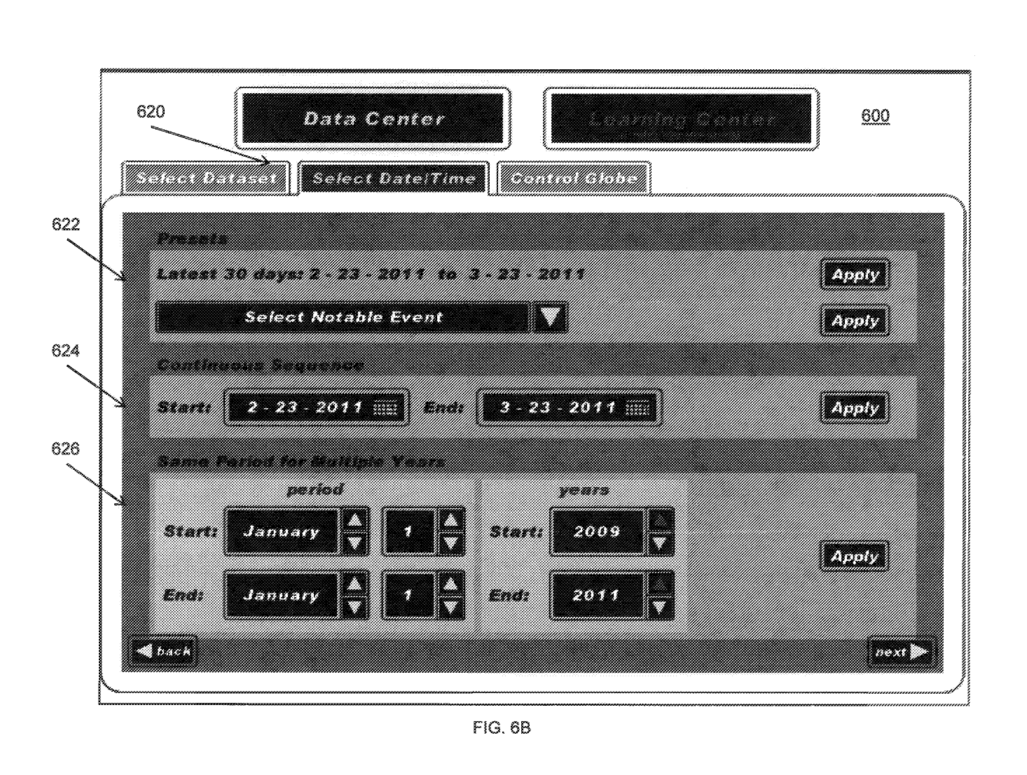

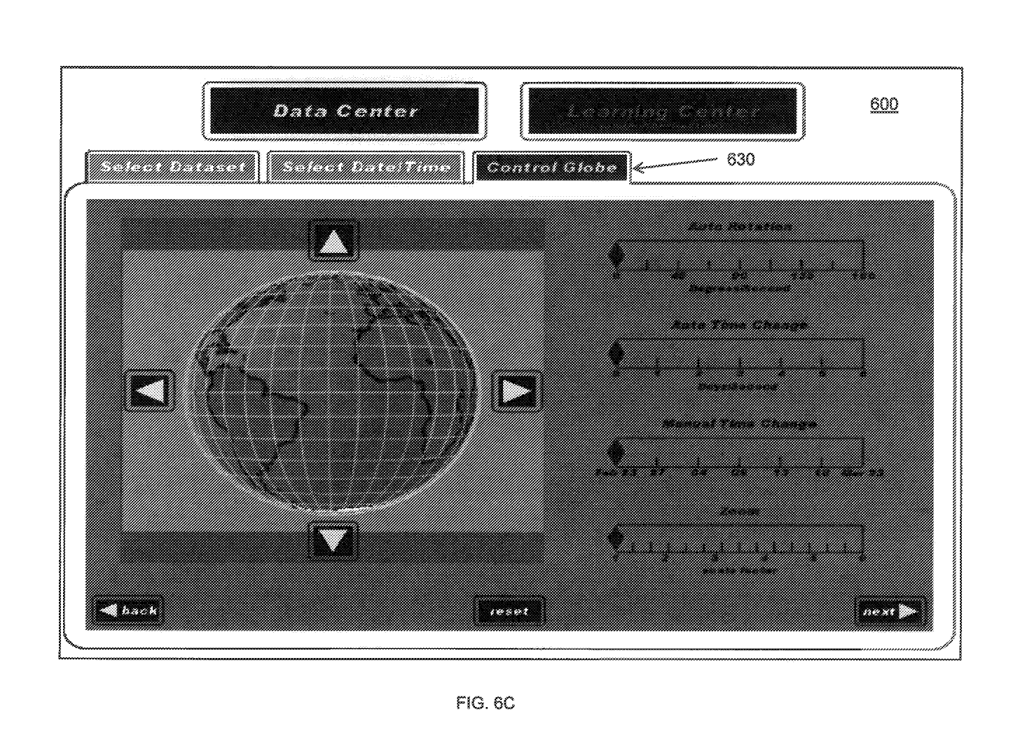

FIGS. 6A, 6B and 6C illustrate a graphical user interface 600 according to an embodiment of the invention, having a first panel 610, a second panel 620 and a third panel 630. The GUI interface and the engine that drives it is created, expanded, and maintained on the Display Development machine 130. The first panel 610 (the “Select Dataset” panel) allows the end-user to select a data set for the base layer 612 and the option of selecting a second overlay layer 614. The overlay has a sliding bar for adjusting the transparency of that layer. The up/down arrows 616 and 618 at the bottom of the page allow end-users to scroll up or down the growing list of data sets.

The second panel 620 (the “Select Date/Time” panel) allows the end-user to select the desired time-range. In the top section 622, called “Presets”, the default option is the “Latest 30 days”. The next option, “Select Notable Event”, has a drop down menu of events the end-user is likely to be familiar with, such as, for example, Hurricane Katrina or the Japanese earthquake resulting in a Tsunami. The middle section 624 allows the end-user to custom-select a specific data range by using a drop-down calendar that allows them to select month, day, and year for the starting point and ending point of their selection. The bottom section 626 allows the end-user to select a time range over multiple years to compare the differences from one year to the next. This is useful when comparing, for example, the ozone hole from one year to the next, or the decline of arctic sea ice, or the El Niño/La Niña (or ENSO) cycle in the Pacific.

The third panel 630 (the “Control Globe” panel) allows the end-user to control whether or not the earth rotates, or how fast it rotates. The orientation of the globe can also be altered. The end-user can also determine if and how rapidly the data advances, and can zoom closer in on a region-of-interest.

In at least one embodiment of the invention, source files containing global earth observing satellite data and ground-based observations are acquired daily in their diverse native data formats from multiple publicly accessible archive sources. These divergent data types are decompressed and reprocessed to generate images that can be compared visually and through time. The data may be imaged in 512×1024 .png images and 2048×4096 .png and saved as Keyhole Markup Language (KML) files. The data can be preserved in at least two common formats, e.g., NetCDF and idl .sav formats. Global earth observing satellite and ground-based images representing the five elemental spheres, (hydrosphere/water, lithosphere/land, atmosphere/air, cryosphere/ice, and biosphere/life) with added data from the anthrosphere/human are then displayed on client computing devices such as kiosks, configured laptop and desktop computers, hand held devices and through a cloud computing network system.

In at least one embodiment of the invention, the Earth Today code includes ingestion and processing. The ingestion of data sets from diverse sources can be performed by the Earth Today server using computer program instructions written in Unix C++ and open source code. The data can be processed into a format suitable for the Earth Today system. This process can contain many steps, including initial unpacking of the native data format, screening for bad data, remapping the data into the grid used by Earth Today, and reformatting the data. This can be performed on the Earth Today server using computer program instructions written in UNIX C++ custom code or IDL custom code.

The Earth Today display computer program instructions (e.g., written using Apple X-Code) can enable a viewer to manipulate data sets, time ranges, and global orientation. Data collections can include several related data sets. For example a coral reef watch collection might include sea surface temperature, sea surface temperature anomalies, coral stress, clouds, and rainfall. A pollution watch collection might include aerosols, sulfur dioxide, nitrogen dioxide, carbon monoxide, surface winds, clouds, rainfall, air temperature, population density and lights at night. A storm watch collection might include clouds, winds, rain, sea surface temperature, and lightning strikes. A solid earth collection might include earthquakes, volcanoes, and maps of fault lines by type and a graphical display that explains the different types of faults. A natural hazards collection might include earthquakes, volcanoes, fires, aerosols, severe storms (e.g., rain, wind, clouds, sea surface temperature)). A biosphere collection might include population, vegetation, ocean chlorophyll concentration, and coral reef distress).

At least one embodiment of the invention provides a uniformly gridded level 3 data product for a vast range of data sets. The data set range can span multiple satellite instrument observations. For example, the data sets for ozone, snow & ice, vegetation, and clouds encompass several generations of satellite observations stitched seamlessly together in the data base to maximize the scope.

The raw data displayed on the system can be provided by multiple satellites and instruments. For example, the Aura satellite can provide ozone (O3), aerosol (UV), formaldehyde (HCOH), and/or sulfur dioxide (SO2) data. The Aqua satellite and/or the Atmospheric Infrared Sounder (AIRS) instrument can provide carbon monoxide (CO) and methane (CH4) data. Furthermore, cloud and water vapor data can be provided by NOAA's Geostationary Operational Environmental Satellite (GOES) and/or the Imager and the Sounder instrument; rainfall data can be provided by the Tropical Rainfall Measuring Mission (TRMM) satellite and/or the TMI radar sensor. Another rainfall measuring satellite is the Global Precipitation Measurement (GPM). Lightning data can be provided from ground-based lightning network instruments (e.g., TRMM lightning sensor (LIS)).

In addition, the NOAA Polar-orbiting Operational Environmental Satellites (POES) satellites and/or the TIROS Operational Vertical Sounder (TOVS) instrument assimilated through a Global Forecast System National Centers for Environmental Prediction (GFS NCEP) Satellite series model can provide wind, wind vectors, tropopause height, and/or land surface temperature data. Sea surface temperatures (sst) and anomalies can be provided by the Aqua and Terra satellites, through the Moderate Resolution Imaging Spectroradiometer (MODIS) instrument, the Global Change Observation Mission—Water (GCOM-W) satellite, the Advanced Microwave Scanning Radiometer (AMSR) instrument, and/or the AMSR-E instrument. The Aqua satellite, the GCOM-W satellite, the AMSR instrument, and/or the AMSR-E instrument can also provide soil moisture data. The Aqua satellite, the AMSR-E instrument, the AMSR instrument, the GCOM-W satellite, can provide national snow and ice data (NISE), snow cover, ice cover, and/or sea ice data. Any of these satellites can be replaced by data from newer satellites/sensors become available or discontinued if a satellite/sensor ceases to produce data.

Furthermore, USGS and/or Smithsonian ground-based instruments can provide earthquakes and/or volcano eruption data. The MODIS instrument, the Aqua and/or the Terra satellites can provide data relating to the normalized difference vegetation index (NDVI), fires, sea surface temperature, and sea surface temperature anomalies. Ocean chlorophyll concentrations can be provided by the Aqua satellite, the Sea-viewing Wide Field of View Sensor (SeaWiFS) instrument, the MODIS instrument, on the SeaStar satellite. Night light data can be provided by the Defense Meteorological Satellite Program (DMSP), the National Polar Earth Observing Satellite System (NPOESS) Preparatory Program (satellite), and/or the Visible Infrared Imaging Radiometer Suite (NPP VIIRS) (instrument). Population and infant mortality data can be provided by the Center for International Earth Science Information Network Statistics (CIESIN).

The Earth Today system can acquire raw data files by downloading the files over the internet (e.g., using UNIX software utilities file transfer protocol (ftp), secure file transfer protocol (sftp), hypertext transfer protocol, (http), and secure copy protocol (scp). Several data sets (e.g., Aqua, Terra, and/or Aura Satellite data sets) can be archived in hierarchical data format (HDF). Several data products can be packed within an HDF; for instance, as many as 600 data products can be packed together. The data arrays determined to be of the greatest interest and/or have the greatest physical impact are evaluated and selected for display on the Earth Today system. The relevant data arrays can be extracted from the HDF files.

For example, a higher quality aerosol product that uses five MODIS bands and measuring multiple wavelengths is selected over a lower quality aerosol product that uses only one to three MODIS bands, measuring fewer wavelengths. In another example, carbon monoxide levels are measured at different elevations ranging from the stratosphere, 200 hectopascals (hPa), (˜7 miles or 11.26 km), through the troposphere to about one mile 790 hPa (1 mile, or 1.6 km) above the earth's surface using thermal infrared (IR) bands. The Earth Today system can use the 700 hPa (1.5 miles or 2.4 km) level, which is low enough to record the results of human activity on the earth's surface but high enough to ensure reliable satellite measurements.

The ocean, land and atmospheric groups can use different compression schemes and different grids. All of the data from each day can be compressed and remapped into a cylindrical projection (also called a “lat-lon projection”), which can be wrapped onto a spherical earth projection on the computer monitor. A time sequence can be generated from a series of frames viewed in succession. If a data set is available once a day, the sequence can update once per day. If data is available every 6 hours, the sequence can updates four times in a day. The animated sequences can be adjusted according to the frequency of updates so that the frame-rates are consistently even between data sets with a different number of updates per day.

The Earth Today system can primarily download “level 2 data” products, which provide the latitude and longitude of each data point. After the level 2 data is ingested, data that has been flagged by the data generator as bad or missing data can be removed. Ingested data can include a high resolution level 3 data set that needs to be re-gridded.

A level 3 data product can be created by averaging the level 2 data into bins that are defined by the level 3 grid. A bin can be defined as a latitude/longitude range. Before final averaging, additional filters on the data can be applied to eliminate out-of-range data or other anomalies. Bins with no data can be filled using a “nearest neighbor” fill technique. Data from occasional missing days can be filled by time-interpolating between existing days. A customized filtering system can be used that is tailored to each data set, for example, by consulting with various earth scientists within each field. Moreover, a single formatting standard and image standard can be used among multiple data sets.

In at least one embodiment of the invention, final products are generated and output from the gridded level 3 data, wherein the final products include portable network graphics (.png) images (e.g., 1024×512 resolution, 4096×2048 resolution), corresponding color bars, legends, date range, and/or time stamps, IDL .sav files, NetCDF files, and KML files. Scientific experts and/or advisors can compose screen text and audio files to describe each date set. Explanatory movies can be generated using the visual Earth Today products, animation, and/or video clips for a learning center. Additionally, larger format .png files and/or the color bars can be used to generate .kmz files (zipped compressed .kml files for Google Earth) and text captions to accompany the .kmz files. Thus, a comprehensive and wide-ranging set of complete products can be produced for a variety of customers, ranging from science and museum displays data use of actual data sets to a data browser used by the general public.

The data can be categorized into one or more groups. For example, the atmospheric group, ocean group, land group, ice group, and the point data set group. The atmospheric group can include data from the Aqua, Terra, and/or Aura Satellite instruments, combined with TRMM and GOES cloud and water vapor imagery, and the NCEP global models providing wind and surface temperatures.

The ocean group can include data from the Aqua satellite, Terra satellite, and/or MODIS instrument, including sea surface temperature (SST) and/or SST anomalies. To generate SST anomaly data, current observed SST data can be compared to 30-year climatology data. An image can be generated showing the difference between the 30-year climatology and the current temperatures. The ocean group can include data from Aqua MODIS and/or SeaWiFS, such as ocean color and/or chlorophyll data (e.g., archived as a Level 3 product). This product can include only ocean data, omitting land data. Greater data accuracy can be achieved by only considering ocean areas for “nearest neighbor fill” for missing ocean data only. The Earth Today server can add a MODIS (Blue Marble) land image of the corresponding month to complete the vegetation and chlorophyll concentration image.

In at least one embodiment, land surface data is retrieved from level 3 land surface data, wherein the native format is a tiled, sinusoidal grid. This data can be remapped and re-binned into a latitude/longitude grid using Earth Today's gridding tool. Polar ice products can be archived and retrieved in a polar stereographic projection coordinate system. This data product can be converted to the latitude/longitude cylindrical projection used by the Earth Today system.

In at least one embodiment of the invention, the point data set group includes fire, volcano, earthquake, and/or lightning data, wherein the point data has specific geolocated data sets that are not normally gridded because they are specific, isolated events. In point data sets, the image can be produced through a series of points, indicating latitude, longitude locations and, when applicable, amplitudes of the point data. For images, the plotting symbol can be altered depending on the value of the data. This alteration can include changes in symbol size and/or color. For example, the amplitude of an earthquake is the magnitude of the event. In another example, fire radiant power is measured in a sliding scale from yellow to red to indicate the intensity.

Clouds and water vapor can be imported as “image only”, where the images can be reformatted to match the cylindrical projection format used by the Earth Today displays (e.g., 1024×512, 4096×2048). In at least one embodiment, cloud data includes dynamic image sequences presently acquired from xplanetclouds as a synthesized product that incorporates data from the following geostationary satellites: GOES (U.S.), Meteosat (Europe), and/or Global Monitoring System (GMS) (Japan).

Night lights data can be imported as static composites of global lights as observed at night and compiled by Defense Meteorological Satellite Program (DMSP). The images can be further refined by NASA and NOAA. This data set can also be obtained from the National Polar Earth Observing Satellite System (NPOESS) Preparatory Program (satellite) and/or Visible Infrared Imaging Radiometer Suite (NPP VIIRS) (instrument) by NOAA.

Human activities data can include time interpolated population projections and/or birth/death rates. These data sets can be obtained from the Center for International Earth Science Information Network (CIESIN) as a level 3 latitude/longitude grid. The data sets can be converted into images using specialized display software for easy visual interpretation.

The ingested data can be automatically processed on computers dedicated to the data reformatting process. The final products can be imported to the Earth Today server on a regular schedule using algorithms developed using customized, automated, UNIX scp and ftp command scripts embedded in an extended cron tab. The Earth Today server can store the imported information using file names that organize the files into appropriate folders and in the correct and consistent time sequence. The Earth Today system can generate the “base layer” that includes an imbedded earth map and the overlay transparency layer without the base map.

In at least one embodiment, images can be moved from the Earth Today server to the Earth Today display systems through a custom UNIX importing script that is activated manually or integrated into an automated cron tab that accesses the Earth Today server and requests missing files from the different data sets. The script can check to see which files the Earth Today display systems have already imported and can only imports new or missing files.

More specifically, the custom UNIX importing script can reside on the display system computer. The script can define the directory, IP location of the Earth Today server, the user name, and/or the user password. The script can contain a detailed directory path for each of the relevant data sets contained in the corresponding data directories. Moreover, the script can acquire a listing of all the files available within the relevant data directories on the Earth Today server and determine which files reside in the display system computer and which files are needed from the Earth Today server. The script can then construct and execute UNIX scp commands to acquire all of the new or missing files.

New data categories can be added to the Earth Today display system by identifying the source of desired data, and writing unique custom scripts for importing the desired data. A color bar can be created that accurately portrays the color range used by any particular data set. Screen text can be written in conjunction with the project scientist that describes the data and what it shows. A voice over can also be made, for example, using AT&T text-to-voice tools or equivalent product. The sections of voiceover (pieces) can be gathered and combined in “Final Cut Pro” or equivalent software. A user can go to File/Import/Files and navigate to the folder where the pieces are located, import the pieces, drag the pieces to the sound line, and arrange the pieces. The pieces can be exported as a Quicktime, .wav or equivalent sound only files.

The generated .wav file can be named according to the naming convention, and placed in the captions folder in the corresponding satellite's sub-folder. The timing of the screen text viewing can be synchronized with the voiceover by playing the data set and adjusting numbers on the left of each line in order to adjust the length of time each text line appears on the monitor. A color bar legend can be created by using the command line, obtaining the jpg and/or png files, and convert the files to sgi rgb (convert filename.png sgi:filename.rgb).

The GUI interface can be updated by modifying the Earth Today_SYSTEM Xcode. This can include adding new scripts, updating the number of data sets on display, updating the links to the new data, updating the color bar and legend, etc. Furthermore, the GUI interface can be updated by modifying the interface on the user machine. Specifically, the interface can be updated by adjusting the GUI_list and the index.txt to reflect the new number of data sets displayed, adjusting the total number of data sets, and/or adding new files to corresponding directories where new data is found.

The Earth Today GUI code can be written using Apple Xcode software. The interactive display of the near-real-time and archived data can have three screens. The first screen can display the available data sets as a base layer or a second layer designed to overlay the base layer using a sliding transparency scale. The second screen can allow selection of the desired date range. Tab selections can include the latest 30 days, a preset for a notable event, a date range selection from calendars for a start and stop of a select period of time, and/or a month/date selection that can be compared over multiple years. The third panel can enable the manipulation of the global position and zoom functions. The third panel can also enable the globe to remain stationary or rotate at a variable rate, and/or enable the data to remain stationary or advance at a variable rate. In at least one embodiment, one of two different sliding scales advance the data rate where a first sliding scale automatically advances the data rate while a second sliding scale is manually advances the data rate.

The main panel can call subroutines written to perform different functions used by the GUI interface. A control panel and main nib can coordinate the subroutines including the following: the display of explanatory text that appears on the screen, control of data access, the display of the globe on the screen, control of dual screens (e.g., a first screen displaying the globe and a second screen displaying the GUI tools), control of the selection arrow, control of the calendar appearance and functions, a data panel controlling the data, a date slider, a month control, a number control, a fonts controller, buttons scripts defining screen buttons, screen labels, voice over, interactive options, opening of GL drawing capabilities options, appearance of earthquakes, loading of the .png images, loading of the color bars, controlling of the time bar, controlling of the time slider, and/or controlling of the time stamp.

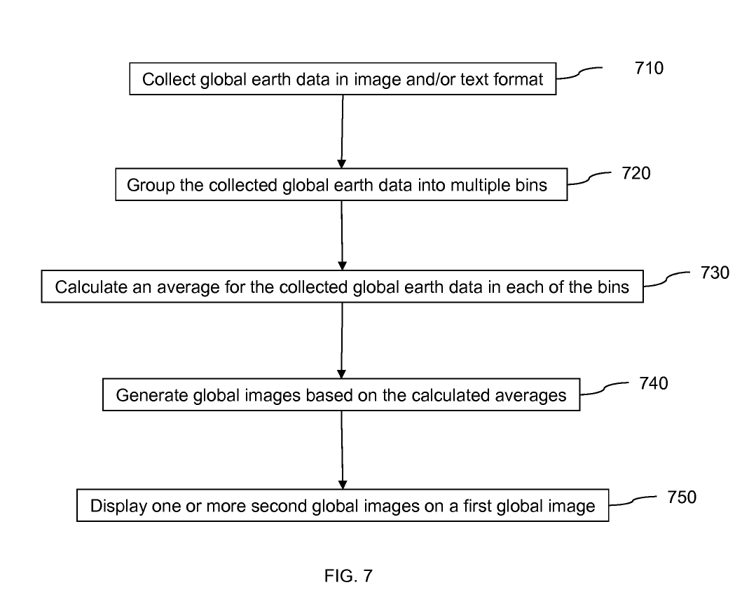

FIG. 7 is a flow diagram illustrating a method for generating and displaying climate system models according to an embodiment of the invention. Global earth data is collected 710 in image and/or text format, for example, with the ingest system. The global earth data can include, atmospheric data, hydrospheric data, lithospheric data, cryospheric data, biospheric data, and/or anthrospheric data.

The collected global earth data is grouped into multiple bins 720 with an analysis engine, wherein each bin defines a geographic area, for example, via latitudinal and longitudinal coordinates. As used herein, the term “analysis engine” includes a computer hardware component that calculates an average for the collected global earth data in each of the bins 730.

Global images are generated with a processor based on the calculated averages 740. As used herein, the term “analysis engine” includes a computer hardware component connected to the processor that generates global images that display the global earth data on a map. One or more second global images are displayed on a first global image 750, wherein the first global image includes first global earth data for a select geographic area, and the second global image includes second global earth data for the select geographic area.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of at least one other feature, integer, step, operation, element, component, and/or groups thereof.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
collecting global earth data, the global earth data including at least one of image data and text data, the global earth data including at least one of atmospheric data, hydrospheric data, lithospheric data, cryospheric data, biospheric data, and anthrospheric data;
grouping the collected global earth data and generating global images with processor protocols;
displaying at least one first global image with data; and
superimposing a second data-only global image over the first global image, wherein a degree of transparency is adjustable by an end user using a GUI interface.

2. The method according to claim 1, further comprising adjusting a transparency of the second data-only global image that has been superimposed over the first global image which includes a combined image of the earth and observed data.

3. The method according to claim 1, wherein said collecting of the global earth data comprises collecting real-time global earth data.

4. The method according to claim 1, further comprising storing the global earth data and the global images in an electronic historical archive, wherein said displaying of the first and second global images comprising retrieving the first and second global images from the electronic historical archive.

5. The method according to claim 1, wherein the global images are animated by the end user, wherein the end user selects a time sequence of frames including one or more layers, wherein the frames are advanced to generate a movie sequence, and wherein the end user modifies the selection to instantly view another animation.

6. The method according to claim 1, wherein said collecting of the global earth data includes automatically extracting the global earth data from multiple data sources without human interaction.

7. The method according to claim 6, wherein said automatically extracting of the global earth data is performed at predefined time intervals.

8. The method according to claim 1, wherein the global earth data includes data in at least three different formats, and wherein said method further comprises reprocessing the global earth data into one of a first format and a second format.

9. The method according to claim 1, wherein:
the atmospheric data includes at least one of meteorological data, trace gas data, and aerosol data;
the hydrospheric data includes at least one of sea surface temperature data, sea surface temperature anomaly data, rainfall, and lightning;
the lithospheric data includes at least one of seismic data, volcano data, soil moisture data; the cryospheric data includes at least one of snow data and ice data; and
the anthrospheric data includes at least one of lights at night, human population data, energy use data, fire data, birth data, and death data, and
wherein a series of still graphical reference images include plate boundaries with differentiated earthquake faults, geographical boundaries, coral reef locations, and a graphic model of wind current patterns.

10. A method comprising:
automatically extracting global earth data from multiple data sources with a data collector, the global earth data including data in at least five different formats, the different formats including images, overlay transparent images, Keyhole Markup Language (KML), NetCDF files, and idl .sav files, and wherein the range of global earth data provided includes atmospheric, hydrospheric, lithospheric, cryospheric, biospheric, and anthrospheric;
reprocessing the global earth data with a processor connected to the data collector into one of a first format or a second format, wherein the first format comprises a base layer, and wherein the second format comprises an overlay with transparency;
generating global images with the processor based on the extracted global earth data, wherein the global images display the global earth data into a cylindrical map projection displayable on a spherical projection
receiving the global images from the processor in a display device, the display device displays the processed global data sets,
wherein the global earth data includes image data and text data,
wherein the global earth data includes atmospheric data, hydrospheric data, lithospheric data, cryospheric data, biospheric data, and anthrospheric data,
wherein the display device displays at least one second global image on a first global image, the first global image including first global earth data for a select geographic area, and the second global image including second global earth data for the select geographic area.

11. The method according to claim 10, further comprising adjusting a transparency of the first global image and the second global image.

12. The method according to claim 10, further comprising storing the global earth data and the global images in an electronic historical archive, wherein said displaying of the first and second global images comprising retrieving the first and second global images from the electronic historical archive.

13. The method according to claim 10, wherein the first global image includes an animated sequence of global images of the first global earth data for the select geographic area, and wherein the second global image includes an animated sequence of global images of the second global earth data for the select geographic area.

14. The method according to claim 10, wherein said automatically extracting of the global earth data is performed at predefined time intervals.

15. The method according to claim 10, wherein:
the atmospheric data includes meteorological data, trace gas data, and aerosol data;
the hydrospheric data includes sea surface temperature data, sea surface temperature anomaly data, rainfall, lighting strikes the lithospheric data includes seismic data, volcano data, soil moisture data, the cryospheric data includes snow data and ice data; and
the anthrospheric data includes lights at night, human population data, energy use data, fire data, birth data, and death data,
wherein a series of still graphical reference images include plate boundaries with differentiated earthquake faults, geographical boundaries, coral reef locations, and a graphic model of wind current patterns.

16. A system comprising:
a data collector for collecting global earth data, the global earth data including at least one of image data and text data, the global earth data including at least one of atmospheric data, hydrospheric data, lithospheric data, cryospheric data, biospheric data, and anthrospheric data;
an analysis engine connected to said data collector, said analysis engine groups the collected global earth data into multiple bins, each bin defining a geographic area, said analysis engine calculates an average for the collected global earth data in each of the bins;
a processor connected to said analysis engine, said processor generates global images based on the collected global earth data, the global images displaying the global earth data on a map; and
a display connected to said processor, said display displays at least one second global image on a first global image, the first global image including first global earth data for a select geographic area, and the second global image including second global earth data for the select geographic area.

17. The system according to claim 1, further comprising an interface for adjusting a transparency of at least one of the first global image and the second global image.

18. The system according to claim 1, further comprising a data repository for storing the global earth data and the global images.

19. The system according to claim 1, wherein the global earth data includes data in at least three different formats, and wherein said processor reprocesses the global earth data into one of a first format and a second format.

20. The system according to claim 1, wherein:
the atmospheric data includes at least one of meteorological data, trace gas data, and aerosol data;
the hydrospheric data includes at least one of sea surface temperature, sea surface temperature anomalies, rainfall, and lighting;
the lithospheric data includes at least one of seismic data, volcano data, soil, and moisture data;
the cryospheric data includes at least one of snow data and ice data; and
the anthrospheric data includes at least one of lights at night, human population data, energy use data, fire data, birth data, and death data,
wherein a series of still graphical reference images include plate boundaries with differentiated earthquake faults, geographical boundaries, coral reef locations, and a graphic model of wind current patterns.
